(19) United States
(12) Patent Application Publication
(10) Pub. No.: US 2008/0017433 A1
(43) Pub. Date: Jan. 24, 2008

(54) CLIMBING DEVICE

(75) Inventor: Michael Taft, Jerusalem (IL)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: Majic Wheels Corp., Newark, DE (US)

(21) Appl. No.: 11/863,307

(22) Filed: Sep. 28, 2007

Related U.S. Application Data
(63) Continuation-in-part of application No. PCT/IL06/00498, filed on Apr. 23, 2006.

(51) Int. Cl. B60K 17/34

(52) U.S. Cl. 180/252; 180/233

(57) ABSTRACT

A device adapted for movement over inclined surfaces and inverted surfaces. The device comprises at least one front wheel mounted for rotation on a body potion having at least one means for abutting against the inclined surface. The abutting means may be displaced rearwardly from at least one front wheel. The front wheel or wheels may comprise a layer of sticky material that is adapted for providing temporary adhesion to the inclined surface where the sticky layer enables adhering the device over the surface at least during motion of the device there over. The surface of the front wheel(s) may be rough to enlarge the contacting-area between the front wheel(s) and the inclined surface. The device may further comprise suitable motor means operatively connected to at least one front wheel for providing a locomotive force thereto.

The present invention relates generally to the field of moving devices and more particularly to devices capable of climbing inclined surfaces such as walls and ramps, and inverted horizontal surfaces such as ceilings

### BACKGROUND OF THE INVENTION

Enabling a device such as a vehicle to propel through and traverse inclined surfaces, including vertical and inverted surfaces has many and varied applications.

Specifically, vehicles capable of vertical motion are known in the art, and may be divided into 4 groups:

(A) Magnetic Traction Devices

This group of climbing devices comprises locomotion means, for enabling the device to travel over a surface, and magnetic traction means for ensuring that the device stays in contact with the surface during the motion. An example of such devices is described in U.S. Pat. No. 3,810,515, in the form of a toy where the locomotion means, wheels, is separate from the traction means, a magnet carried by the toy. Other examples are described in JP 2068275 and JP 60078877, where the traction means are incorporated into the locomotion means, in the form of endless caterpillar-like tracks having magnets on the pads of the tracks. While such devices work reasonably well, they are strictly limited to applications, where the surface to be traversed is ferrous or magnetic, and thus cannot be used over any other type of surface.

(B) Suction-Cup Traction Devices

In this group of climbing devices, the devices also comprise locomotion means, for enabling the device to travel over a surface, but the traction means for ensuring that the device stays in contact with the surface during locomotion there over is based on a suction-cup adhesion. When the suction cups are placed in contact with the surface to form an air-tight seal there between and air is evacuated from the cup, a strong suction force is generated that enables the cup to remain on the surface. Most such applications are for descending a surface. For example, in U.S. Pat. No. 3,638,354, a toy capable of moving down a surface only is described, having prying members on a chassis, which operate in a synchronized manner on either one in turn of fore and aft suctions cups mounted for rotation in the chassis, such as to unstick the same according to the position of feet which are comprised on each of a forward and aft pair of wheels that are mounted in the chassis. This arrangement allows the toy to advance downwards in an end-over-end fashion. However, in U.S. Pat. No. 4,477,998, a wall-climbing toy is described, having an endless track arrangement which comprises a plurality of suction cups. Wires connected between each cups and the track bend the cups toward a surface-confronting position as the cups in turn approach the surface. Such devices, however, only work on smoothly polished surfaces such as glass, for example, where the seal between the cup and the surface may be maintained. Moreover, no such devices are known for making the transition from a horizontal to a vertical surface, or from a vertical to an inverted surface.

(C) Tumbling Devices,

In this group of devices a sticky material is provided at a plurality of projections thereon. Typically, the device is temporarily adhered to a vertical surface at one or several of these projections via the sticky material, and the location of the centre of gravity of the device is such that the weight of the device plies the stuck projections off the surface, whereupon another projection or projections are forced against the surfaces adhering the device thereto. This causes the device to descend over a vertical surface in a tumble-down motion, and such devices in the form of toys are described in U.S. Pat. No. 5,947,792, GB 2,222,958 and U.S. Pat. No. 5,683,285, for example, wherein the sticky material is provided at the end of “limbs” of toys, which are in the shape of humans or animals. In U.S. Pat. No. 5,916,008, U.S. Pat. No. 5,746,641 and U.S. Pat. No. 4,764,148, the sticky material is provided in the form of lobes around the periphery of a wheel, which is mounted for rotation in a vehicle-type toy. The lobes in turn provide temporary traction on the vertical surface as the force of gravity causes the toy to descend, in a similar manner to the tumble-down toys, with the major difference that the “tumble-down” effect is restricted only to the wheel, which rotates as a result, producing relatively smooth downward motion for the toy. While these devices are able to descend a regular type of wall, they are totally unable to climb up a wall, or to traverse an inverted surface such as a ceiling. In fact, by using gravity as their locomotive force, these devices are by definition unable to traverse surfaces, which require the device to go against the force of gravity, such as up a vertical wall or along a ceiling. Accordingly, these devices teach against considering such devices when desiring to provide a device for climbing up a wall or other vertical surface.

(D) Devices for Specialized Traction Surfaces

Some devices in the prior art are specialty designed to travel over specialized traction surfaces, which may be vertical. For example, in U.S. Pat. No. 5,720,646, a toy vehicle is described having at least one traction wheel having a plurality of hook-shaped members, which engage with hoop-shaped members comprised on, a mating surface. Thus, this type of device can only ascend vertical walls, which comprise the particular mating surface that is compatible with the hook members on the wheel, and is thus not at all suitable for universal use.

Thus, the prior art devices generally relate to devices for descending a vertical wall, and devices for climbing are restricted to those that require a ferrous, polished or special surface for traction. None of the devices described above enable the locomotion over regular walls, inverted surfaces, or the transition from one to another of such mutually inclined surfaces.

It is an aim of the present invention to provide a device that overcomes the disadvantages of prior art devices.

It is another aim of the present invention is to provide a device for locomotion over a non-polished surface having any inclination, including vertical, horizontal and inverted.

It is another aim of the present invention to provide such a device that also provides for the propelling thereof from one surface to another surface inclined to the first surface.

Other purposes and advantages of the invention will appear as the description proceeds.

### SUMMARY OF THE INVENTION

The present invention relates to a device adapted for movement over inclined surfaces, said device comprising at least one front wheel mounted for rotation on a body portion having at least one means for abutting against such inclined surfaces. The abutting means may be placed rearwardly from said at least one front wheel, where the front wheel comprises a layer of sticky material that may be adapted for providing temporary adhesion to the inclined surface. The sticky material and the movement of the device may enable adhering the device with respect to the inclined surface at least during motion of said device there over.

According to embodiments of the invention, suitable motor means may be operatively connected to the fount wheel for providing a locomotive force thereto.

Optionally, the device may comprise a plurality of front wheels mounted on an axle operatively connected to the motor means, where the motor means enable rotating the front wheels in a desirable rotation direction. According to some embodiments of the invention, the device may comprise two front wheels each on either side of the body portion. The surface of the front wheel(s) may be roughened in the manufacturing process of the wheels, to allow increasing of the contact force applied by the front wheel(s) upon the inclined surface. Additionally, since more wheel surface-area may be available due to the roughening a larger amount of sticky material may cover the wheel(s).

The means for abutting may comprise at least one rear wheel mounted for rotation on the body portion of the device. Additionally, a plurality of rear wheels may be mounted on an axle operatively connected to the motor means, where the motor means may enable rotating the axle, whereby the rear wheels may be rotated. According to some embodiments of the invention the means for abutting may comprise two rear wheels each on either side of said body portion.

Advantageously, the front wheels and the rear wheels may be operatively connected to the motor means in such a manner as to provide substantially similar surface velocities.

The sticky material may be a soft or a resilient material, capable of deforming under a predetermined tensile forces. The sticky material may include a tackifier, which may impart a tackiness or stickiness to the exposed surface of the material, where the sticky material may be typically a polymeric material comprising a sticky gelatinous composition, including a melt blend admixture of any one of poly (stynme-ethylene-butylene-styrene) triblock copolymer and plasticizing oils, or polymerizing styrene, butadiene, 6naphthenic oil, calcium carbonate and hydrogenated polyterpene resin, among others.

According to some embodiments of the invention, the layer of the sticky material may be applied to a tape, which may be removably wrapped around the periphery of each said front wheel. The tape may comprise a plurality of loop-shaped members or hook-shaped members which engage with a plurality of hook-shaped members or loop shaped members, respectively, comprised on the outer periphery of each said front wheel to releasably fix the tape thereon. The adhesion provided between the tape and the periphery of said wheel may be substantially greater than the adhesion provided between the layer of sticky material and the inclined surface upon which the device is to move. The sticky material may be attached to the tape by any attaching means known in the art such as, for example, sewing, stitching or stalling.

The device may be adapted for mounting thereon, and thus may comprise, at least one work-performing device and/or at least one suitable sensor.

The device may further comprise electrical power means suitable for powering the motor means. The electrical power means may comprise an on-board power means, such as, for example, batteries and/or solar cells. Additionally or alternatively, the electrical power means may comprise an external power source that may be electrically connected to the motor means via an electric cable.

The device may further comprise control means and a control system for controlling the movement of the device, for example, for remotely controlling the direction of the device's movement.

The device may also further comprise an outer covering.

The device may also be adapted for movement from a first surface to a second surface, inclined with respect to said first surface, for example: the first surface may be a substantially horizontal surface such as a floor, and the second surface may be ubstantially vertical to the first surface, such as a vertical wall. Alternatively, the first surface may be a substantially vertical surface including a wall, and the second surface is an inverted substantially vertical surface including a ceiling. Advantageously, the body portion does not extend forwardly of said front wheels.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 illustrates a plan view of the main elements of a climbing device, according to some embodiments of the invention.

FIG. 2 illustrates an inside view of the climbing device of FIG. 1.

FIG. 3 illustrates a side view of a front wheel of the climbing device of FIG. 2.

FIGS. 4(a), 4(b) and 4(c) schematically illustrate the climbing device of FIGS. 1 to 3 maneuvering from a horizontal surface to a vertical surface.

FIG. 5 illustrates theoretical aspects of the present invention, according to some embodiments of the invention.

FIG. 6 illustrates shock-absorbing means mounted on the climbing device of FIG. 1.

The drawings together with the description make apparent to those skilled in the art how the invention may be embodied in practice.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

### DETAILED DESCRIPTION OF THE INVENTION

The present invention is defined by the claims, the contents of which are to be read as included within the disclosure of the specification, and will now be described by way of example with reference to the accompanying Figures.

The present invention relates to a device for movement over inclined surfaces, typically against gravity, that is, climbing up, down and across walls or other vertical or inclined surfaces. The device may enable traveling along ceilings and other inverted surfaces and for passing from one surface to another surface inclined thereto, such as, for example, from a floor to a wall, or from a wall to a ceiling. In the present invention, such surfaces need not be ferrous and may be non-polished surfaces. The present invention is particularly adapted for surfaces made from materials, which are not polished or slippery, but instead comprise some roughness, porosity and so on. Such materials may include, for example; regular building materials such as gypsum, cement, plaster and the like, and even dried painted surfaces covering virtually any undersurface material, however, the surface can be also smooth or even glass-like.

Herein, the term “inclined surface” refers to any surface inclined to the horizontal “floor-surface”, and includes vertical surfaces as well as inverted surfaces such as ceilings, which may be inclined 180 degrees or at another angle to the horizontal surface.

The present invention may be in the form of a vehicle (10) having at least one and preferably a pair of front wheels (20) mounted for rotation on a body portion (30) that extends at least rearwardly, and having at least one means for abutting against a surface, said means being displaced rearwardly from said front wheels (20). However, the vehicle can be a crawler tractor, for example, having a track instead of a wheel. The front wheels (20) may comprise a layer of sticky material that may be adapted for providing temporary adhesion between the vehicle (10) and the surface being traversed. Typically the adhesion may be sufficient to support the weight of the vehicle (10) at least during motion upon the inclined surface. Motor means coupled to the front wheels (20) may be provided, where the motor means may be operatively connected or connectable to a suitable power source enabling the movement of the device in any desired and/or predetermined direction.

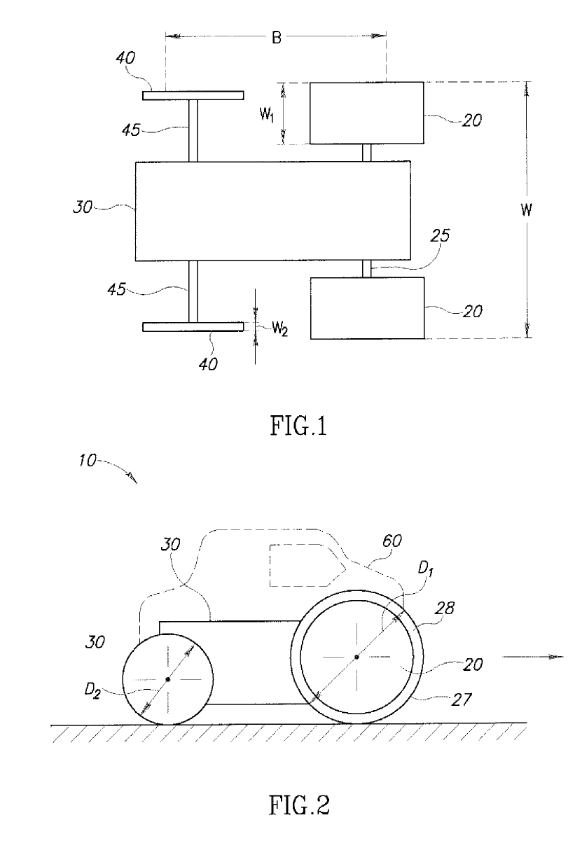

Thus, referring to FIGS. 1 and 2, a preferred embodiment of the device according to the present invention is in the form of a vehicle (10) having a pair of front wheels (20) mounted for rotation on either side of a body portion (30) via a common axle (25). The body portion (30) may carry a suitable motor (not shown), typically a DC electric motor, operatively connected to the front wheels (20) via axle (25) for providing a turning or locomotive motion to the wheels (20). A suitable gear train (not shown) may be provided between the motor and the axle (25) for increasing the torque of the motor and/or for reducing the rotational velocity of the wheels (20), as desired. The body portion (30) may extend rearwardly from the front wheels (20), and in this embodiment, the means for abutting against a surface may comprise a pair of rear wheels (40) mounted for rotation at the rear end of the body portion (30) via common axle (45). The motor is also operatively connected to the rear wheels (40) for providing substantially the same surface velocity for these wheels as for the front wheels (20). The surface velocity is defined herein as the linear velocity of the wheel with respect to the surface over which the wheel is rotating. The velocity is equivalent to the product of the angular rotation of the wheel and the radius thereof. Thus, a suitable gear train and/or a belt system may be used for transmitting the required torque from the motor to the rear wheels (40), for example.

Optionally, a lightweight outer covering (60) may be provided in any desired shape, for decorative or other purposes.

Optionally, work performing devices and/or sensors (not shown) may be mounted onto the body portion (30) as desired, according to the application of the vehicle (10). For example such work performing devices and/or sensors may be lightweight to reduce the weight load added to the vehicle (10).

According to embodiments of the invention, a layer (28) of sticky material may be mounted on the cylindrical peripheries of each front wheel (20) to provide a sticky surface (27). Any suitable sticky material may be used for the sticky layer (28), as long as the material ensures suitable adhesion to a non-polished surface, as will be described in more detail below. The sticky material may be, for example, a soft or resilient material, which deforms under a predetermined tensile force. Preferably, the material may include a tackifier, which imparts a tackiness or stickiness to the exposed surface of the material. Typically, such materials are polymeric, and their constituents are well known. It is therefore only necessary to blend the suitable constituents to achieve the desired degree of deformability and stickiness. Thus, the sticky material may comprise a sticky gelatinous composition, for example, including a melt blend admixture of poly (styrene-ethylene-butylene-styrene) triblock copolymer and plasticizing oils, or polymerizing styrene, butadiene, naphthenic oil, calcium carbonate and hydrogenated poly terpene resin, among others.

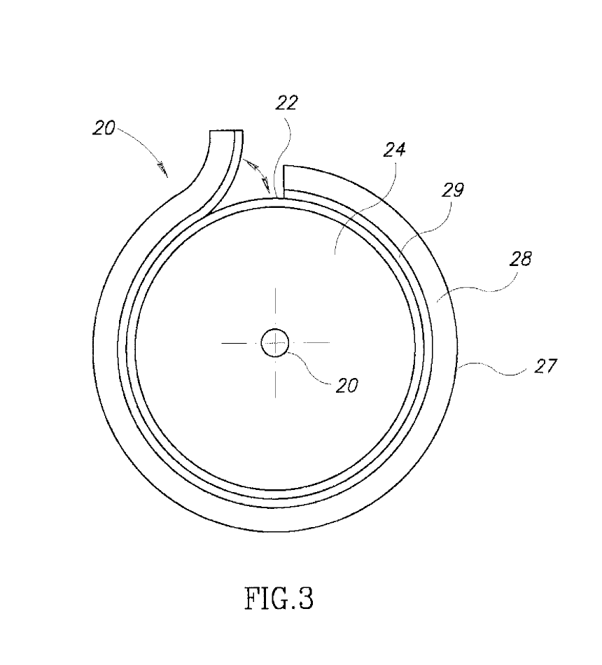

Referring to FIG. 3 in particular, the sticky layer (28) may be applied to a tape (29) which may be removably wrapped around the periphery (22) of each huh (24) of each wheel (20). This arrangement may facilitate in replacing the sticky layer (28) when needed or desired, as well as the cleaning of the sticky layer (28) of dirt and so on that may adhere to the sticky surface (27) with the sticky layer (28) may be cleaned by using soapy water, for example, and subsequent drying, or by placing adhesive tape thereon and then removing the layer (28) along with the tape. Furthermore, by being removable, a set comprising a plurality of different interchangeable tapes may be provided with each vehicle (10), where each tape may differ from the other by width, depth of sticky layer, material of sticky layer, surface area of the sticky layer and so on. Thus, a user may be able choose the most appropriate tape for each particular type of wall. The tape (29) may comprise a plurality of loop shaped members or hook-shaped members that may engage with a plurality of hook-shaped members or loop-shaped members, respectively, comprised on the outer periphery (22) of the wheel hub (24) to releasably fix the tape (29) thereon. The adhesion provided between the tape (29) and the periphery (22) should be greater that the adhesion between the sticky layer (28) and the surface on which the vehicle (10) is to operate. The sticky layer (28) may be attached to the tape (29) by any suitable means, including, for example, sewing, stitching, or stapling means. In such cases, the stitches or staples may be arranged along the circumference of the periphery, i.e., normal to the axis of the front wheel (20), which may prevent from interrupting the sticking motion as the front wheel (20) rotates over the inclined surface.

According to some embodiments of the invention, the dimension of the front wheels' width (W1) may be chosen according to the stickiness of the sticky layer (28) relative to the surface to be traversed, and according to the weight of the vehicle (10) and torque of the motor. The greater the stickiness, the less the exposed surface of material that may be required, and thus width (W1) may be reduced. The greater the weight of the vehicle (10), or the greater the torque that can be provided by the motor, the larger width (W1) may be required.

The diameter (D1) of the front wheels (20) may also be an important dimension. Smaller diameters (D1) may have increased resistance to unsticking, and the resilience of the sticky material may actually lead to a jerking or spring-like action between the sticky layer and the inclined surface, and may actually force the device off the inclined surface. However, as the diameter of the front wheel (20) is increased, the centre of gravity thereof, and thus the vehicle (10), moves away from the (vertical) inclined surface over which the vehicle (10) is to traverse, increasing the outward toppling moment on the vehicle (10). On the other hand, the greater the diameter, the greater the coupling moment provided at the periphery, which aids in unsticking the sticky layer from the surface when required. An optimum diameter for (D1) can be established according to the general weight of the vehicle, the motor rating and general dimensions of the vehicle (10).

The effective surface area of the sticky material can be adjusted as shown and as will be shown herein after in several manners such as providing Velcro straps, for example, that can be adhered onto the sticky material and enlarge the effective surface area. The Velcro tapes can be adhered in any direction as desired so as to change the characteristics of the vehicle (10).

According to embodiments of the invention, the effective contact area of the front wheels (20) may be enlarged, for example, by increasing the roughness of the wheels' (20) surface. A higher contact area of the front wheel(s) (20) may enable a larger adhering area(s) between the front wheel(s) (20) and the inclined surface upon which the vehicle (10) or the device may climb. The increase of the front wheel(s) (20) roughness may be carried out in the manufacturing process. The roughening of the surface may be carried out, for example, by slotting of the surface of the front wheels (20) in the manufacturing process.

The engine may typically be powerful enough to develop the torque required to raise the vehicle (10) over a vertical wall; and for unsticking the layer (28) from the wall on parts of the front wheel (20) no longer in contact with the wall, as the front wheel (20) rotates over the wall. At the same time, a low-weight motor may be advantageous in achieving the aims of the present invention.

The surface or linear velocity of the wheels (20) can be optimized for achieving an optimal adhesion and mobility of the vehicle (10) with respect to the inclined surface being traversed. On the one hand, having a low linear velocity may ultimately result in the wheels naturally unsticking from the vertical or inverted surfaces by due to the weight of the vehicle (10). On the other hand, if the linear velocity is too great for a given configuration of the vehicle (10), there may be insufficient “residence time” between any part of the sticky layer (28) and the wall to properly stick the wheels (20) onto the inclined surface.

According to embodiments of the invention, the centre of gravity of the vehicle (10) may be maintained as close as possible to the front wheels (20), and preferably just rearwards of the axle (25).

Additionally, the center of gravity of the vehicle (10) may be maintained as close to the inclined surface as possible, when this surface is vertical.

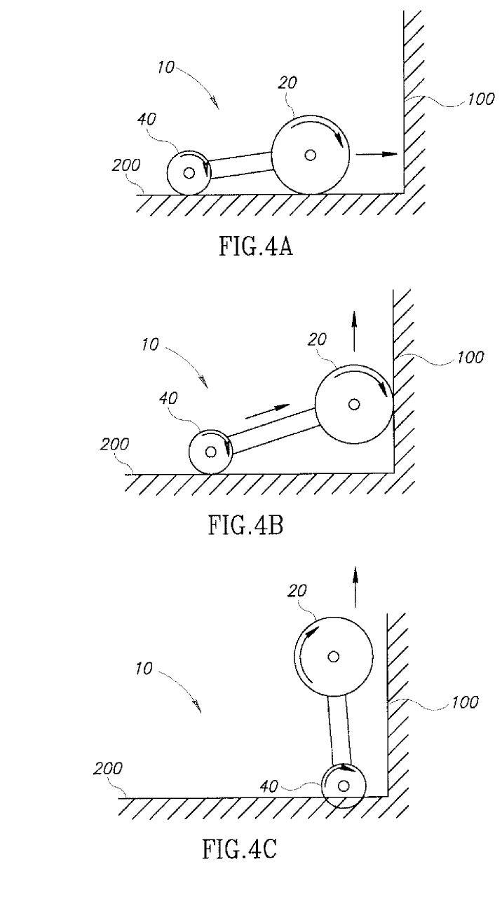

Additionally, the overall weight of the vehicle (10) should be as small as possible. According to these embodiments, the rear wheels (40) may not comprise a layer of sticky material, rather, the rear wheels (40) may comprise a periphery made from a rubber-like material to improve the stability and traction of the vehicle (10), and to prevent the rear wheels (40) from sliding over. The rear wheels (40) may be particularly useful in enabling the vehicle (10) to maneuver from one surface to another surface inclined thereto. Thus, referring to FIGS. 4(a), 4(b) and 4(c), the vehicle is illustrated in FIG. 4(a), according to some embodiments of the invention, as approaching a substantially vertical wall (100) while moving on a substantially horizontal surface (200). When reaching the wall (100), the front wheels (20) may begin to climb up the wall (100), while the rear wheels (40) provide a moving support and traction over the horizontal surface (200), as illustrated in FIG. 4(b). As the front wheels (20) continue to climb up the wall (100), the rear wheels (40) eventually reach the wall (100) and climb up by virtue of the traction provided by the front wheels (20). The maneuver from an inclined surface to another inclined surface, in particular from a vertical wall to a ceiling may be similar to that described regarding the maneuver from a horizontal surface to a vertical wall, mutatis mutandis.

Optionally, the rear wheels (40) may comprise a diameter (D2) which may be smaller than the diameter (D1) of the front wheels (20), and a width (W2) that may be also narrower than the width (W1) of the front wheels (20). Alternatively, the rear wheels (40) may comprise a diameter (D2) which may be substantially the same or greater than the diameter (D1) of the front wheels (20), and/or a width (W2) that is also substantially the same or wider than the width (W1) of the front wheels (20).

The side distance (B), which may be the distance between the centers of each two same side wheels (20 and 40)—meaning between the front wheel (20) and the rear wheel (40) of the same side of the vehicle (10, may also be optimized. If the side distance (B) is too small, apart from the obvious problem of possible interfacing, narrowing the side distance (B) may reduce the ability of the vehicle (10) to maneuver from one inclined surface to another surface. On the other hand, as the side distance (B) is increased, the center of gravity moves rearwards, which has a de stabilizing effect on the vehicle (10) when attempting to climb a wall.

Further, it may also be advantageous for the body portion (30) not to extend excessively in a forward direction from the wheels (20), as this may interfere with the vehicle's ability to traverse from one surface to another surface inclined thereto. Similarly, it may also be advantageous for the body portion (30) not to extend excessively in a rearwards direction from the wheels (40), as this may interfere with the vehicle's ability to traverse from one surface to another surface inclined thereto.

It should be mentioned that the wheels might not be necessarily round; they can be in a polygonal shape or in an ellipsoid shape, for example. When using a wheel having a polygonal shape, the surface area that sticks to the wall may be larger than the surface area of a round wheel that sticks to the wall in a particular moment. Alternatively, a crawler tractor's track may be used instead of a wheel, in order to provide a larger surface area that sticks to the inclined surface at a given moment.

Optionally, the surface area of the sticky material can be enlarged and roughened by using “hairy-like” protrusions that are made also from the same sticky material. Vacuum caps can be also incorporated in the surface area of the sticky material so as to allow both mechanisms to work together to increase the stickiness of the vehicle (10).

Optionally, the vehicle (10) may comprise an on-board power source (not shown) operatively connected to the motor. The power source may thus include batteries, preferably high power and lightweight batteries, and/or suitable solar cells, particularly if the vehicle (10) is to be operated in a well-lit environment. Alternatively, the power supplied to the motor may be provided by an external source via a suitable cable connected to the motor.

This latter arrangement may comprise a tether which may serve to control the movements of the vehicle (10) and also a safety line if the vehicle (10) should fall from a height. In the latter arrangement, an operator of the vehicle may operate a control box containing suitable batteries or connected to an electric generator or electric mains, wherein the control box is connected to the vehicle (10) via the cable.

Optionally, suitable control means (not shown) may be provided for controlling the movement of the vehicle (10), via a control cable or via suitable signal transmission means and reception means, based on radio waves, microwaves, infrared and other known control signal means/Further optionally, either one or both pairs of said front wheels (20) and rear wheels (40) may be pivoted to permit sideways maneuvering over a surface.

According to some embodiments of the invention, particularly in traversing a vertical wall as well as a ceiling, and in making the transition between the floor to the wall, and the wall to the ceiling. In particular, the rear wheels (40) provide a stable moving support while the vehicle moves from one surface to another, such as a floor to a wall and then to a ceiling. Furthermore, Applicant has also determined that the following non-limiting dimensions and physical characteristics for the vehicle (10) are advantageous in achieving the aims of the present invention.

The According to some embodiments of the invention, the diameter (D1) may be between 6 cm and 10 cm, preferably between 7 cm and 8 cm, and more preferably 7.5 cm. The diameter (D2) may be advantageously between 4 cm and 8 cm, preferably between 5 cm and 7 cm, and more preferably 5.5 cm. The width (W1) of the front wheels (20) may be preferably between 2.5 cm and about 3 cm, and preferably about 2.7 cm. The width (W2) of the rear wheels may be preferably between 0.2 cm and about 0.3 cm, and preferably about 0.25 cm. The side distance (B) may be preferably about 10 cm to about 12 cm, and preferably about 11.5 cm. The overall width (W) of the vehicle may be preferably between about 9 cm and 15 cm, more preferably between about 10 cm and 13 cm, and even more preferably about 11 cm. The weight of the vehicle my be preferably between about 110 gms and about 160 gms, and preferably between about 115 gms and about 155 gms, not including an external power source and cable operatively connected to the motor. The applicant, successfully employed a 3V electric motor as the motor means, coupled to an external battery pack of four 1.5V AA batteries (1.8 Ampeach), via a flexible electric cable.

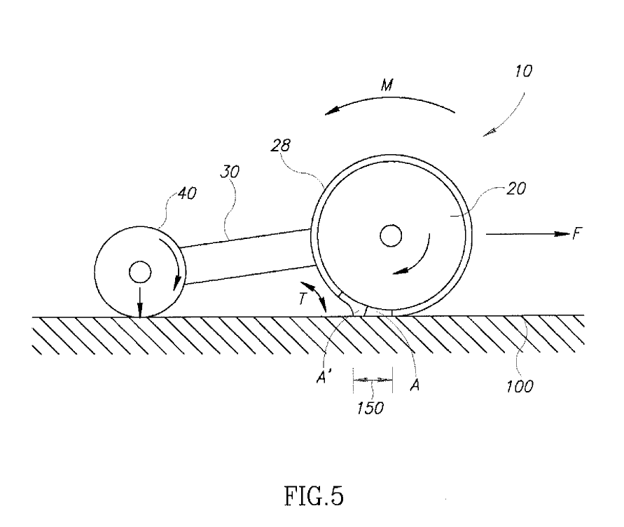

Referring to FIG. 5, the front wheel (20) of vehicle (10) may be depicted while rotating over a surface (10Q), typically a vertical surface, in a clockwise direction. As the wheel (20) turns, a part (A) along the periphery of the sticky layer (28) may temporarily adhere to the surface (100) at the contact area (150). As the front wheel (20) continues to rotate to advance the vehicle (10) in a forward direction (F), this particular part (A) of the periphery of the sticky layer (28) that was adhered to the surface (100) may be drawn from the surface (100). However it may be unable to do so instantaneously, because of the adherence properties of the material in the layer (28) with respect to the wall (100), and there may be a certain delay in the unsticking caused by the drawing. Moreover, since the sticky layer (28) is made from a soft or resilient material that may be easily deformed, as this part of the wheel (20) continues on its upward travel away from the surface (100), at least a portion of part (A) may stretch from the layer (28) to the surface (100), as illustrated schematically in FIG. 4 as portion (A). This stretching in the portion of the layer (28) may provide a tensile force (T) between the wheel (20) and the surface (100) which may create an anticlockwise momentum on the wheel (20) which needs to be balanced by a greater torque from the motor. This in turn may create an anticlockwise momentum (M) on the body portion (30), forcing the rear wheels (40) against the surface (100), and thus improving traction thereof. This effect may facilitate in maintaining the vehicle (10) in proper attitude with respect to the surface, regardless of the inclination thereof, and thus prevent toppling of the vehicle (10). In particular, when the vehicle 10) is in climbing mode, the rear wheels may be kept in contact with the surface (100), assisting in providing locomotive force over the surface (100). In the absence of such rear traction, the rear wheels (40) may detach from the surface (100) and hang freely, reducing the traction of the vehicle, and also dangerously moving the centre of gravity of the vehicle away from the surface (100).

According to some embodiments of the invention, the rear wheels (40) may be of greater diameter than the front wheels (20), and this may help the traction of the rear wheels (40) with respect to the surface (100). It is interesting to note that if the rear wheels (40) were also to comprise a sticky material as in the case of the front wheels (20), this could introduce another anticlockwise moment for the body portion (30) about the rear wheels that may urge the front wheels (20) to unstick from the surface. However, the rear wheels (40) may be configured with substantially less sticky material than the front wheels (20) so that the stickiness of the rear wheels (40) does not cause the front wheels (20) to unstick.

According to other embodiments of the invention, the rear wheels (40) of the preferred embodiment may be replaced with a single rear wheel (40), or a plurality of rear wheels (40), mutatis mutandis.

According to additional embodiments of the invention, the rear wheels (40) may be replaced with one, two or a plurality of projections that may be configured to extend from the rear part of the body portion (30) such as to provide contact with the surface being traversed. While arguably not as effective as the rear wheels (40) in enabling the vehicle (10) to maneuver from one surface to another surface inclined thereto, nor in providing locomotive force over a surface, the projections help to maintain the vehicle (10) in proper attitude with respect to the surface being traversed.

According to additional embodiments of the invention, the vehicle (10) may comprise one, two or a plurality of rear wheels (40) or projections, the vehicle (10) may comprise a single, two or a plurality of front wheels (20). In the case of a single front wheel (20), the motor may be coupled to the front wheel (20) in a proper manner. For example, the motor may be seated adjacent to the wheel hub (25) of one of the front wheels (20), which may be connected to the body portion (30) by external load carrying members in a Y-configuration. Other configurations are known in the art for providing operative connection between the motor and a single front wheel of a vehicle. The adhesion provided by the one or plurality of front wheels (20) in such embodiments should in each case be comparable to that provided by the pair of wheels (20) of the preferred embodiment, i.e., at least sufficient to permit the vehicle to traverse a vertical wall, and preferably also at least sufficient to traverse an inverted horizontal surface.

According to additional embodiments of the invention, the vehicle (10) may comprise a single, two or a plurality of rear wheels (40) having a sticky layer similar to that of the front wheels (20), of which there may be one, two or a plurality thereof. However, the adhesion of the front wheel(s) (20) to the inclined surface should be higher than the adhesion enabled by the sticky layer of the rear wheel(s) (40) to prevent the front wheel(s) (20) from being jerked off from the inclined surface.

According to additional embodiments, the rear wheels (40) of the may be replaced with one, two or a plurality of rear wheels (40) or of said projections, or with one, two or a plurality of rear wheels having a sticky layer similar to that of the front wheels (20), of which there may be one, two or a plurality thereof. In such embodiments, the body portion (30) may comprise any number of wheels disposed intermediately between the front wheel(s) (20) and the rear wheel(s) (40). These intermediately disposed wheels comprise a sticky layer over the peripheries thereof, and are also operatively connected to the motor to provide traction over a surface at substantially the same linear velocity as the front and rear wheels. Moreover, if the inclined surface is traversed, the adhesion of the front wheel(s)) (20) needs to be sufficiently greater than that of the intermediate wheels, the adhesion of each intermediate wheel needs to be sufficiently greater than that of the adjacent wheel thereto in a rearwards direction, and ultimately the adhesion of rear wheel(s) (40) needs to be the lowest of all.

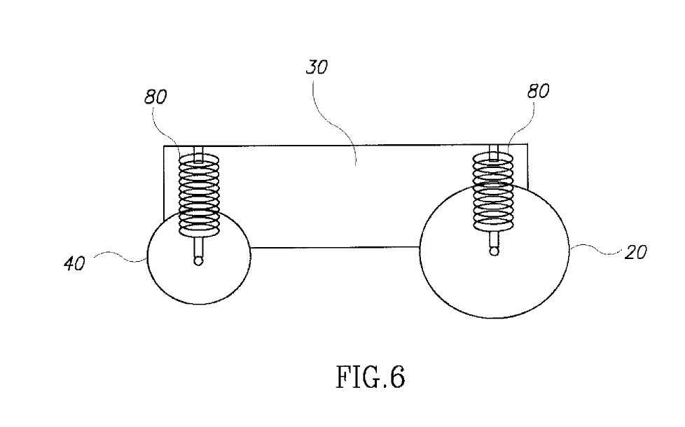

According to some embodiments of the invention, as illustrated in FIG. 6, at least some of the wheels (front (20) and/or rear (40)) may be connected to the body portion (30) through shock-absorbing means (80) such as springs, for example, that may connect the center of the front wheels (20) and/or the center of the rear wheels (40) to the body portion (30) of the vehicle (10). The shock-absorbing means (80) may facilitate in keeping the wheels substantially adjacent to the inclined surface to facilitate in absorbing shocks applied by the inclined surface upon the vehicle (10). This may be especially efficient in cases where the vehicle (10) reaches rough areas such as bumps, pits and the like that may cause the vehicle (10) to turn over and/or the sticky material to be insufficient in holding the front wheel (20) adjacent to the surface.

In anyone of the above embodiments, the motor and power source may be replaced with a wind-up motor, adapted to provide the torque required to propel the vehicle (10) in a similar manner to that described for the above embodiment with the motor, mutatis mutandis.

While in the foregoing description describes in detail only a few specific embodiments of the invention it will be understood by those skilled in the art that the invention is not limited thereto and that other variations in form and details may be possible without departing from the scope and spirit of the invention herein disclosed or exceeding the scope of the claims.

What is claimed is:

1. A device adapted for movement over inclined surfaces, said device comprising at least one front wheel mounted for rotation on a body portion having at least one means for abutting against such a surface, said abutting means being displaced rearwardly from said at least one front wheel, wherein said at least one front wheel comprises a layer of sticky material that is adapted for providing temporary adhesion to said surface, wherein said adhesion is at least sufficient to adhere the device with respect to such a surface at least during motion of said device there over, and suitable motor means operatively connected at least to said at least one front wheel for providing a locomotive force thereto,
wherein said at least one front wheel has a rough surface to allow a larger contact area of said wheel to adhere to the inclined surface.

2. The device as claimed in claim 1, comprising a plurality of said front wheels mounted on an axle operatively connected to said motor means.

3. The device as claimed in Claim 2, comprising two said front wheels one each on either side of said body portion.

4. The device as claimed in claim 3, wherein said means for abutting comprises at least one rear wheel mounted for rotation on said body portion, wherein at least one said rear wheel is operatively connected to said motor means through an axle.

5. The device as claimed in claim 4, wherein said means for abutting comprises two said rear wheels one each on either side of said body portion.

6. The device as claimed in claim 5, wherein said front wheels and said rear wheels are operatively connected to said motor means in such a manner as to provide similar surface velocities.

7. The device as claimed in claim 1, wherein said sticky material is a soft or resilient material, capable of deforming under a tensile force.

8. The device as claimed in claim 1, wherein said sticky material includes a tackifier which imparts a tackiness to the exposed surface of the material.

9. The device as claimed in claim 8, wherein said sticky material is one of a polymeric material and a gelatinous composition.

10. The device as claimed in claim 1, wherein said layer of sticky material is applied to a tape which is removably wrapped around the periphery of each said front wheel.

11. The device as claimed in claim 10, wherein said tape comprises a plurality of loop-shaped members or hook-shaped members, which engage with a plurality of hook-shaped members or loop-shaped members, respectively, comprised on the outer periphery of each said front wheel to releasably fix the tape thereon.

12. The device as claimed in claim 11, wherein the adhesion provided between the tape and the periphery of said wheel is substantially greater that the adhesion provided between the layer of sticky material and the surface on which the device is to operate.

13. The device as claimed in claims 12, wherein the sticky material is attached onto the tape by attaching means, wherein said attaching means is one of: sawing, stitching and stapling means,
wherein said attaching means is aligned along the circumference of the periphery of the front wheel.

14. The device as claimed in claim 1, further comprising at least one work-performing device and at least one sensor, wherein said device enables at least one said sensor to be mounted upon said device.

15. The device as claimed in claim 1, further comprising power means suitable for powering said motor means.

16. The device as claimed in claim 1, further comprising control means and a control system for controlling the movement of said device.

17. The device as claimed in claim 1, further comprising an outer covering.

18. The device as claimed in claim 1, further comprising of a vertical wall, wherein said device that is adapted for movement over inclined surfaces enables moving over said wall, wherein said wall is non-smooth.

19. The device as claimed in claim 1, wherein said device is adapted for movement over an inclined surface comprising an inverted wall including a ceiling.

20. The device as claimed in claim 1, wherein said device is adapted for movement from a first surface to a second surface inclined with respect to said first surface, wherein said first surface is a substantially horizontal surface including a floor, and said second surface is a substantially vertical surface including a wall.

21. The device as claimed in claim 11, wherein said at least one front wheel is a polygonal wheel.

22. The device as claimed in claim 1, wherein said layer of sticky material comprises a plurality of sticky layers that can be removed from one another.

23. The device as claimed in claim 1 wherein said abutting means is at least one rear wheel, wherein said at least one front wheel and said at least one rear wheel are connected to said body portion through shock-absorbing means enabling to keep said wheels substantially adjacent to the inclined surface to facilitate in absorbing shocks applied by said surface.
